(19) United States
(12) Patent Application Publication
(10) Pub. No.: US 2005/0159163 A1
(43) Pub. Date: Jul. 21, 2005

(54) Method for generating and transmitting a control message in a broadband wireless access communication system

(75) Inventors: Sunny Chang, Suwon-si (KR); Yun-Sang Park, Yeongtong-gu (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., GYEONGGI-DO (KR)

(21) Appl. No.: 11/001,961

(22) Filed: Dec. 2, 2004

(30) Foreign Application Priority Data
Jan. 16, 2004 (KR) 3457/2004

(51) Int. Cl. H04Q 7/20

(52) U.S. Cl. 455/450; 455/422.1

(57) ABSTRACT

A method for generating and transmitting a transmission frame for transmitting a control message in a broadband wireless access communication system. The method determines if burst profiles for all subscriber terminals are changed. As a result of the determination, if the burst profiles for only some of the subscriber terminals are changed, a base station forms and transmits the control message including a field for identifying each of the subscriber terminals and a changed burst profile for each of the subscriber terminals.

### PRIORITY

This application claims priority to an application entitled “Method for Generating and Transmitting Control Message in Broadband Wireless Access Communication System” filed in the Korean Intellectual Property Office on Jan. 16, 2004 and assigned Serial No. 2004-3457, the contents of which are hereby incorporated by reference.

### BACKGROUND OF THE INVENTION

1. Field of the Invention

The present invention relates generally to a broadband wireless access communication system, and more particularly to a method for generating and transmitting a transmission frame including a control message in a broadband wireless access communication system.

2. Description of the Related Art

Recently, a broadband wireless access communication system (called “4th Generation (4G) communication system” or “IEEE 802.16 communication system”) has been researched and developed in order to provide high-speed services. The broadband wireless access communication system, which has been suggested in an IEEE 802.16 standard, distributes a downlink frame and an uplink frame to a plurality of subscriber terminals whenever transferring a frame to the subscriber terminals. As a result, the broadband wireless communication system transfers control messages such as a downlink-map (DL-map) and an up link-map (UL-map) between a base station and a subscriber terminal whenever transferring the frame. Also, the broadband wireless communication system enables the base station to share control messages such as a downlink channel descriptor (DCD) and an uplink channel descriptor (UCD) with the subscriber terminal. The DL-map, the UL-map, the DCD, and the UCD will be described in detail herein below with reference to FIG. 1.

FIG. 1 illustrates a conventional data frame structure of a broadband wireless access communication system employing an orthogonal frequency division multiple access method. Referring to FIG. 1, a conventional data frame of the broadband wireless access communication system includes both uplinks and downlinks. Also, the conventional data frame includes both a transmit time gap (TTG) and a receive time gap (RTG) between the uplinks and the downlinks. As illustrated in FIG. 1, the conventional data frame includes a DL sub-frame for the downlink and a UL sub-frame for the up link. In addition, the conventional data frame includes a preamble, an uplink map (UL-map), and a downlink map (DL-map). In_particular, FIG. 1 illustrates a frame including a DCD message and a UCD message positioned after the DL-map and the UP-map in order to transfer the DCD message and the UCD message.

Sub frames for the downlink and the uplink (DL sub-frame/UL sub-frame) are divided into several intervals by means of the DL-map and the UL-map. Herein, the DL-map and the UL-map provide position information of each interval and a connection ID (CID), a downlink interval usage code (DIUC), an uplink interval usage code (UIUC) for each interval. Herein, the CID serves as an identification code of a subscriber and represents a subscriber terminal receiving data from a corresponding interval. Also, the DIUC/UIUC are values representing usage, a modulation type, and an encoding code (e.g., FEC: frame error control code). That is, the DIUC and the UIUC represent usage for data of a corresponding interval, a modulation type for modulating data of a corresponding interval, and an FEC code for encoding data of a corresponding interval.

FIG. 2 illustrates a user of each interval and an example of assigning DIUC/UIUC to the user in the DL/UL maps of the conventional data frame in the broadband wireless access communication system. Referring to FIG. 2, a downlink frame is divided into seven intervals through the DL-map, and the seven intervals are assigned to seven users (users A to F). Additionally, each interval is designed in such a manner that data corresponding to each interval is processed through a modulation and an encoding code mapped with one of DIUCs 1 to 7. For example, an interval assigned to the user A and an interval assigned to the user F are designed in such a manner that data corresponding to the interval assigned to the user A is processed using a modulation type and an encoding code mapped with DIUC 1, and data corresponding to the interval assigned to the user F is processed using a modulation type and an encoding code mapped with DIUC 7.

An uplink frame is divided into five intervals through the UL-map. Herein, the five intervals are assigned to four users (users A to D). Also, different UIUCs are assigned for the five intervals. More specifically, two different intervals having mutually different UIUCs are assigned to the user B. That is, a first interval assigned to the user B is designed in such a manner that data corresponding to the first interval is processed using a modulation type and an encoding code mapped with UIUC0. Further, a second interval assigned to the user B is designed in such a manner that data corresponding to the second interval is processed using a modulation type and an encoding code mapped with UIUC4. Herein, the DIUC/UIUC are generally represented as numerals 0 to 15 according to usage, modulation types, and a type of encoding codes. DIUCs 0 to 12, which are used as data bursts, are mapped with modulation types and types of encoding codes corresponding to each of DIUCs 0 to 12 through downlink/uplink profile information of the DCD/UCD messages (e.g., a pair of a modulation type and an encoding code) so as to be managed.

Additionally, referring to FIG. 3, the UCD message includes information relating to channel encoding (e.g., frequency, contention-based reservation timeout, channel width, initial ranging code, periodic ranging code, bandwidth request code, periodic ranging backoff start, and periodic ranging backoff end) in addition to uplink burst profile information. Parts of such information have values that may change according to channel conditions or have values that are fixed to particular systems. In particular, the available number of UIUCs is 16, and the number of generally used UIUCs is 10 from among the total number of UIUCs representing data intervals of uplink burst profiles in the UCD message. FIG. 3 illustrates a format for channel encoding in a UCD message, which is a control message of a broadband system, and illustrates UCD channel-encoding values of an OFDM physical layer method. Because internal values are information encoded using a type, a length, and a value (hereinafter, referred to as “TLV”), a system can selectively transfer changed variables.

FIG. 4 illustrates an uplink burst profile format of a UCD message in a conventional broadband wireless system employing an OFDMA method. More specifically, FIG. 4 illustrates information encoded with the TLV, which is a sub-variable of the uplink burst profile illustrated in FIG. 3. The number of uplink burst profiles is in a range of 1 to n. Herein, 1 to n represents a code number of an uplink interval usage code (UIUC). In an uplink, n is generally 9, and in a downlink, n is generally 12. Because internal variables of the uplink burst profile are encoded with the TLV, it is possible to selectively transmit only the required variables. However, uplink burst profiles corresponding to the number of UIUCs in a range of 1 to n must be included in one UCD message.

A base station and a subscriber terminal of a broadband wireless access communication system transfer DCD/UCD messages to each other through a downlink frame by a predetermined period of time. The base station and the subscriber terminal modulate/demodulate data frames transmitted/received between them by considering the DCD/UCD messages. As a result, each subscriber terminal downloads and stores the DCD/UCD messages used for a predetermined interval from the base station.

Herein, the DCD/UCD messages may be periodically transferred or transferred when currently used DCD/UCD messages are changed rather than transferred for every frame. For example, when a modulation type or an encoding code (FEC code) mapped with DIUC/UIUC in the DCD/UCD messages is modified, the base station transfers corresponding DCD/UCD messages to the subscriber terminal. That is, DCD/UCD messages are transferred if at least one of channel-encoding information included in the DCD/UCD messages is changed.

FIGS. 5A and 5B illustrate an uplink burst profile frame format of the UCD message when transmitting the UCD message in the conventional broadband wireless system employing an OFDM method. The uplink burst profile frame format illustrated in FIG. 5A will be described on the assumption that the number of UIUCs of the uplink burst profile frame format is ‘3’. Referring to FIG. 5A, it should be understood that uplink burst profiles included in a UCD message are transferred for all UIUCs.

More specifically, when transferring a UCD message, if an uplink burst profile corresponding to UIUC1 from among uplink burst profiles corresponding to the UIUC1 to a UIUCn is changed, uplink burst profiles corresponding to overall n number of UIUCs have to be transferred because only the uplink burst profile corresponding to the first UIUC cannot be transferred. Therefore, a terminal performing an automatic modulation control (AMC) frequently requires a change of a burst profile. Herein, if a corresponding burst profile is not included in the UCD message, burst profiles corresponding to overall UIUCs must be transferred in a UCD message. Accordingly, because wide downlink bandwidth is occupied, overheads increase.

Additionally, there are multiple burst profiles, which correspond to UIUCs, respectively. However, in order to reduce overheads generated when all burst profiles are transmitted, even though the burst profiles have been partially changed as described above, only the changed burst profiles may be selectively transmitted according to necessity.

An example in which only changed burst profiles are selectively transmitted, as described above, will be described below with reference to FIG. 5B.

Referring to FIG. 5B, for example, uplink burst profiles corresponding to three UIUCs are sent. It is assumed that an uplink burst profile corresponding to a first UIUC contains only an FEC code type (type 5), an uplink burst profile corresponding to a second UIUC contains only a ranging data ratio (type 16), and an uplink burst profile corresponding to a third UIUC contains both an FEC code type (type 5) and a ranging data ratio (type 16). A subscriber terminal receives a UCD message containing the burst profiles described above in order of type 5, type 16, type 5, and type 16. Accordingly, the subscriber terminal may determine that the burst profile corresponding to the first UIUC has type 5 and type 16, the burst profile corresponding to the second UIUC has type 5, and the burst profile corresponding to the third UIUC has type 16. That is, when only the changed burst profiles are selectively transmitted as described above, the subscriber terminal may occasionally misjudge the message because it is impossible to identify a UIUC corresponding to each type. Also, the above problems occur when transmitting a DCD message having the same format as the UCD message, and when transmitting the UCD message.

As described above, when transmitting burst profiles corresponding to overall UIUCs representing data intervals in a UCD message, overheads increase because wide downlink bandwidth is occupied. Additionally, when selectively transmitting an FEC code type (type 5) or a ranging data ratio (type 16) corresponding to each of overall UIUCs representing data intervals, it is difficult for a terminal receiving a UCD message to find UIUCs corresponding to the types.

### SUMMARY OF THE INVENTION

Accordingly, the present invention has been designed to solve the above and other problems occurring in the prior art, and a first object of the present invention is to provide an apparatus and a method, which enable a base station of a broadband wireless access communication system to reduce downlink overheads.

A second object of the present invention is to provide a method for forming a control message in such a manner that a base station can support a result of an automatic modulation control in each subscriber terminal.

A third object of the present invention is to provide a method, which enable a subscriber terminal to perform an exact interpretation for a control message.

In order to accomplish the above and other objects, there is provided a method of determining if burst profiles for all subscriber terminals are changed; and if the burst profiles for only some of the subscriber terminals are changed, constructing and transmitting, by the base station, the control message including a field for identifying each of the subscriber terminals and a changed burst profile for each of the subscriber terminals.

Additionally, there is provided a method for generating a control message including an up/downlink burst profile in a wireless access communication system. The method includes the steps of: inserting a field into the control message, the field indicating whether information fields of all of the up/downlink burst profile corresponding to each subscriber terminal UIUC are transmitted or the information fields of some of the up/downlink burst profile are selectively transmitted; and inserting only a data value field from among the information fields of all of the up/downlink burst profile into the control message, if the field indicates that the information fields of all of the up/downlink burst profile are transmitted.

Additionally, a method is provided for generating a control message including an uplink/down link burst profile in a wireless access communication system, wherein the uplink/downlink burst profile includes a field for identifying an uplink/down link interval usage code (UIUC/DIUC) for each of subscriber terminal.

### BRIEF DESCRIPTION OF THE DRAWINGS

The above and other objects, features, and advantages of the present invention will be more apparent from the following detailed description taken in conjunction with the accompanying drawings, in which:

FIG. 1 illustrates a conventional data frame structure of a broadband wireless access communication system employing an OFDMA method;

FIG. 2 illustrates a user of each interval and an example of assigning DIUC/UIUC to the user in the DL/UL maps of the conventional data frame in the broadband wireless access communication system employing an OFDMA method;

FIG. 3 illustrates an example of a UCD message in a conventional broadband wireless access communication system employing an OFDMA method;

FIG. 4 illustrates an example of forming an uplink burst profile of a UCD message in a conventional broadband wireless system employing an OFDMA method;

FIGS. 5A and 5B illustrate an uplink burst profile frame format of a UCD message when transmitting the UCD message in the conventional broadband wireless system employing an OFDM method;

FIG. 6 illustrates an example of a UCD message in a broadband wireless system according to an embodiment of the present invention;

FIG. 7 illustrates an uplink burst profile format of a UCD message in a broadband wireless system according to an embodiment of the present invention;

FIG. 8 illustrates a procedure of transferring a control message in a broadband wireless access communication system according to an embodiment of the present invention; and

FIGS. 9A and 9B are views showing an uplink burst profile frame format of a UCD message when transferring the UCD message in a broadband wireless access communication system according to an embodiment of the present invention.

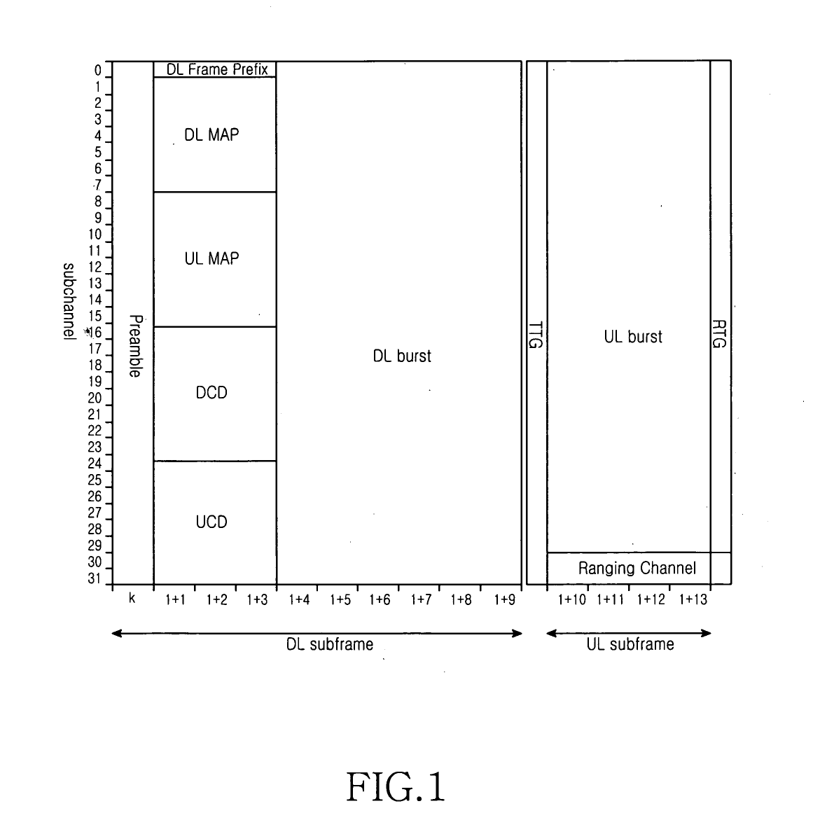

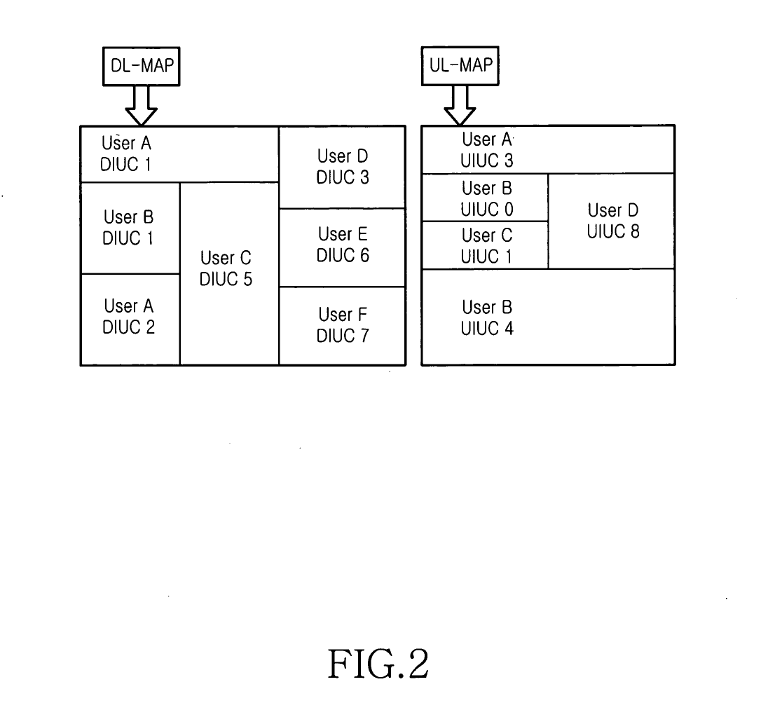

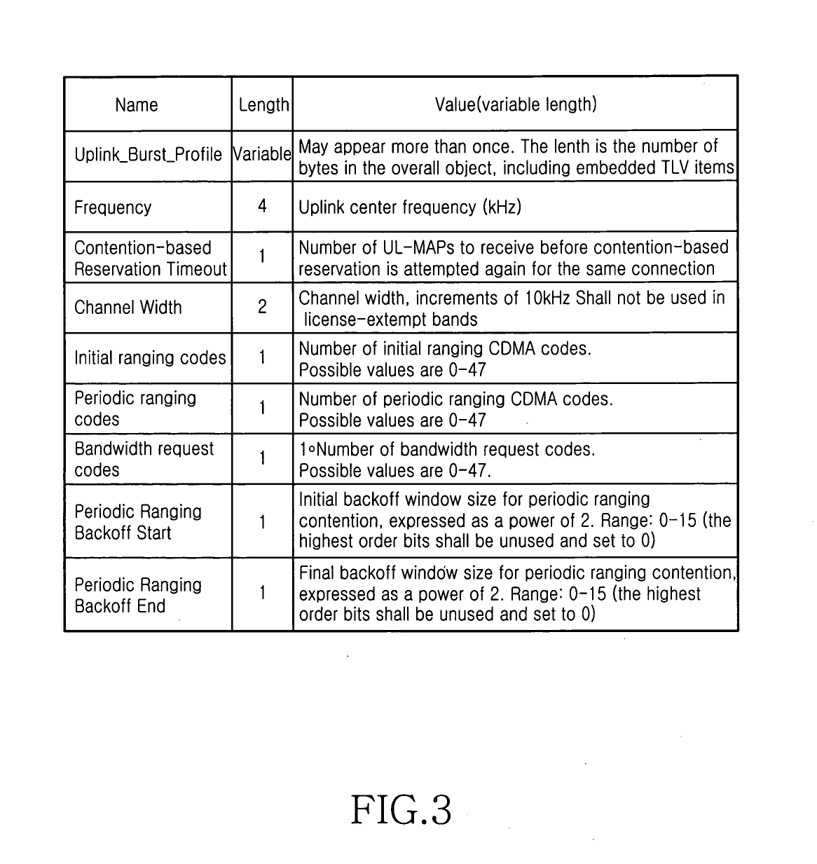

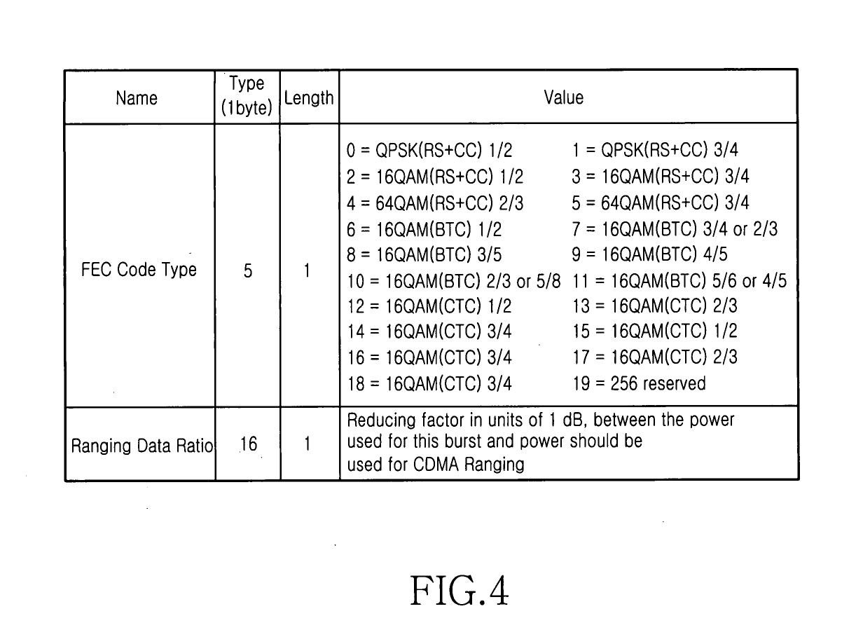

### DETAILED DESCRIPTION OF THE PREFERRED EMBODIMENT

Hereinafter, preferred embodiments of the present invention will be described in detail with reference to the accompanying drawings. Note that the same or similar components in drawings are designated by the same reference numerals although they are shown in different drawings. Additionally, in the following description of the present invention, a detailed description of known functions and configurations incorporated herein will be omitted when it may obscure the subject matter of the present invention.

As indicated above, the present invention relates to a method for formatting control messages in order to reduce a transmission amount of the control messages and more exactly interpret internal information of the control messages in a broadband wireless access communication system. Accordingly, the present invention uses a “Full_Burst_Profile” field for differentiating between a first case of transferring control messages for all information corresponding to all uplink interval usage codes/downlink interval usage codes (UIUCs/DIUCs) and a second case of transferring control messages for information corresponding to a portion of the UIUC/DIUCs.

In the first case, because all FEC code types and all ranging data ratios, which are internal fields of uplink burst profiles corresponding to all UIUCs, must be transferred, it is unnecessary to utilize an overhead of 2 bytes for each uplink burst profile by using both type and length fields of the FEC code type and the ranging data ratio. That is, the “Full_Burst_Profile” field indicates that all fields of the uplink burst profile do not include type and length fields of the FEC code types/the ranging data ratios, but include only value fields of the FEC code types/the ranging data ratios in the order of UIUCs 1 to n.

A UCD message having all information is normally transferred by a predetermined period of time (10 seconds in maximum) for a terminal initially entering into a network. Even if the predetermined period of time does not elapse, data encoded with various TLV in addition to uplink burst profiles should be transferred according to various conditions or a request of a terminal.

The present invention additionally employs a UIUC field in order to prevent difficulty of message interpretation when transmitting only a portion of information of up/down link burst profiles for a portion of UIUC/DIUCs, such that UIUC/DIUCs mapped with up/down link burst profiles information can be exactly found.

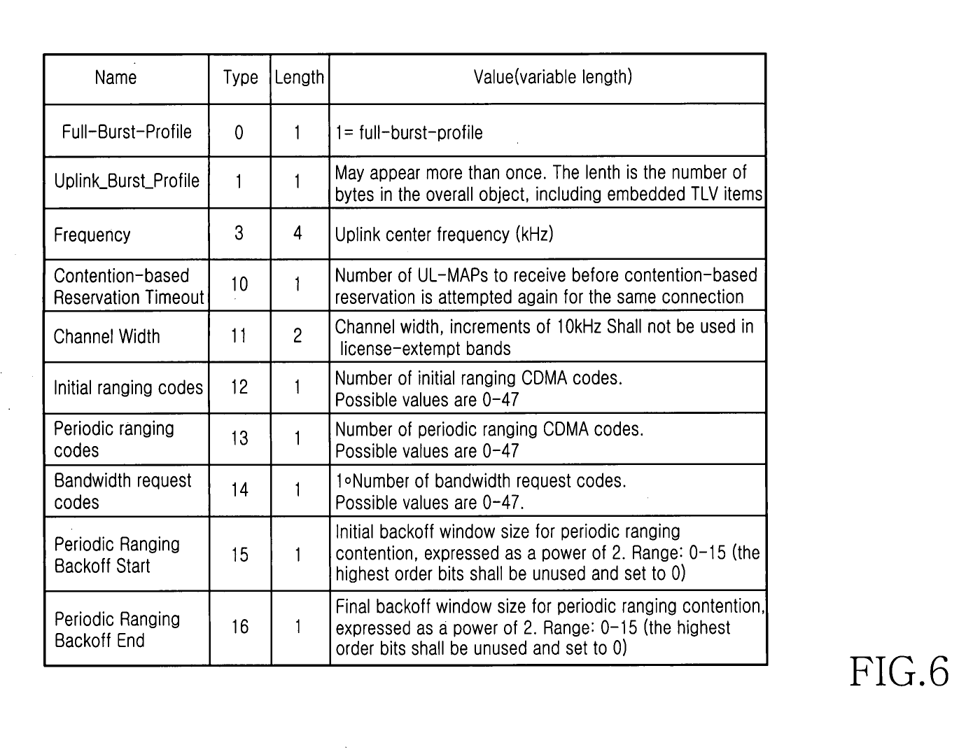

FIG. 6 illustrates an example of a UCD message in a broadband wireless system according to an embodiment of the present invention. Referring to FIG. 6, the UCD message includes uplink burst profile information and information relating to channel encoding (e.g., frequency, contention-based reservation timeout, channel width, initial ranging code, periodic ranging code, bandwidth request code, periodic ranging backoff start, and periodic ranging backoff end). The present invention adds the “Full_Burst_Profile” field to the UCD message, such that the UCD message has only value fields of the uplink burst profile in the order of UIUC1 to UIUCn, without including type and length fields according to a value of the “Full_Burst_Profile” field when the UCD message is transferred. If the “Full_Burst_Profile” field has a value of ‘1’, all uplink burst profiles corresponding to all UIUCs have only value fields in the order of the UIUCs without including type and length fields and are transferred.

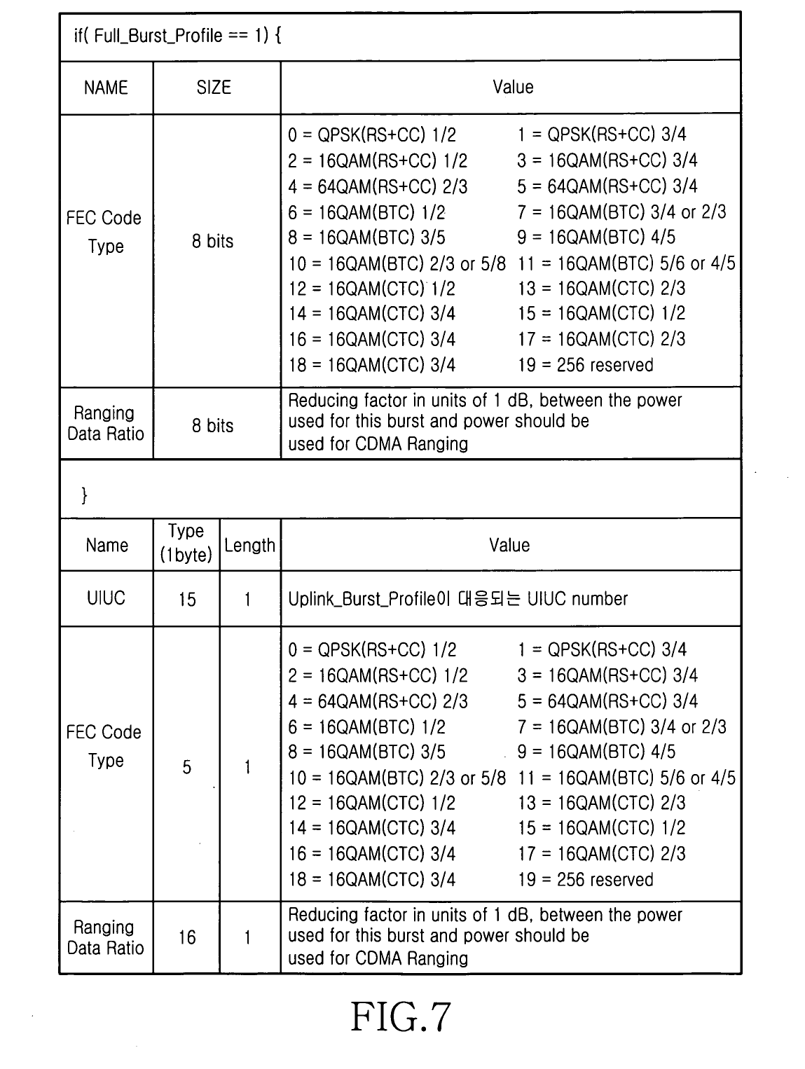

FIG. 7 illustrates an uplink burst profile format of a UCD message in a broadband wireless system according to an embodiment of the present invention. First, if a value field of the “Full_Burst_Profile” field has a value of ‘1’, an uplink burst profile has only a value field without including type and length fields in relation to each UIUC. Additionally, if the value field of the “Full_Burst_Profile” field has a value of ‘0’, the uplink burst profile has a UIUC field mapped with the uplink burst profile, which is inserted into an uplink burst profile TLV encoding channel.

More specifically, the UIUC field has a value of a type field ‘15’, a value of a length field ‘1’, and a value field having a UIUC number corresponding to an uplink burst profile. Accordingly, a terminal receiving the UCD message reads the UIUC field and finds UIUCs mapped with uplink burst profiles TLV-encoded. Also, according to the present invention, although a value of a type field representing the UIUC field is equal to ‘15’, the value of the type field representing the UIUC field can be set as other values because the value ‘15’ is a predetermined value.

Accordingly, if an uplink burst profile TLV-encoded for all UIUCs is not transferred, a base station transfers a UCD message having both a UIUC field and an uplink burst profile TLV-encoded.

As described above, by inserting a UIUC field into an uplink burst profile format, it is possible to find UIUCs mapped with uplink burst profiles that are TLV-encoded. Additionally, when only an uplink burst profile corresponding to one UIUC is changed, only a corresponding uplink burst profile needs to be transferred, instead of transferring uplink burst profiles corresponding to all UIUCs, thereby reducing downlink overheads greatly.

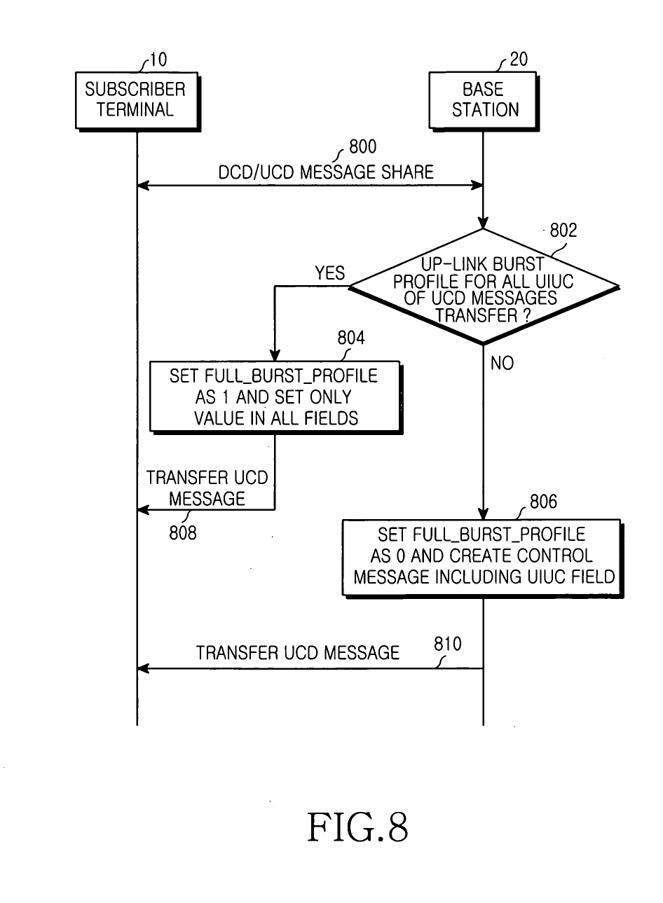

FIG. 8 illustrates a procedure for transferring a control message in a broadband wireless access communication system according to an embodiment of the present invention. In step 800, a subscriber terminal 10 has to receive overall UCD/DCD messages from a base station 20 when initially entering into the base station 20. Thereafter, if uplink burst profiles for all UIUCs have to be transferred when transferring a UCD message in step 802, the base station 20 sets a “Full_Burst_profile” as ‘1’, inserts only value fields of uplink burst profiles for all UIUCs into the UCD message in step 804, and transfers the UCD message to the subscriber terminal 10 in step 808.

However, if an uplink burst profile corresponding to a specific UIUC is transferred when transferring a UCD message in step 802, the base station 20 sets a “Full_Burst_profile” field as ‘0’, inserts a UIUC field for a corresponding UIUC into the uplink burst profile by performing step 806, and transfers the uplink burst profile to the subscriber terminal 10 in step 810.

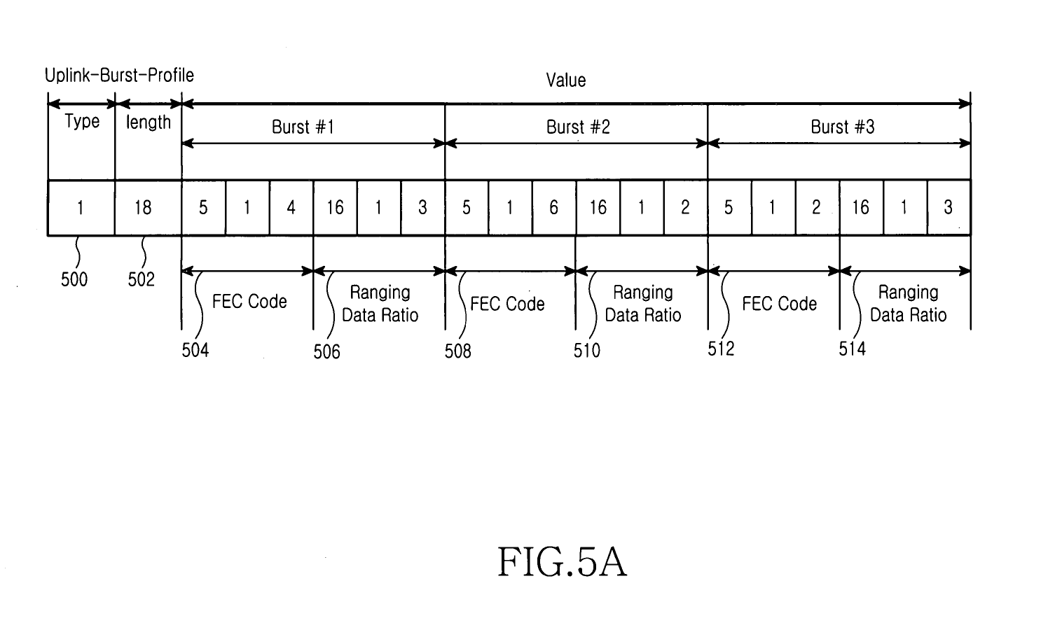

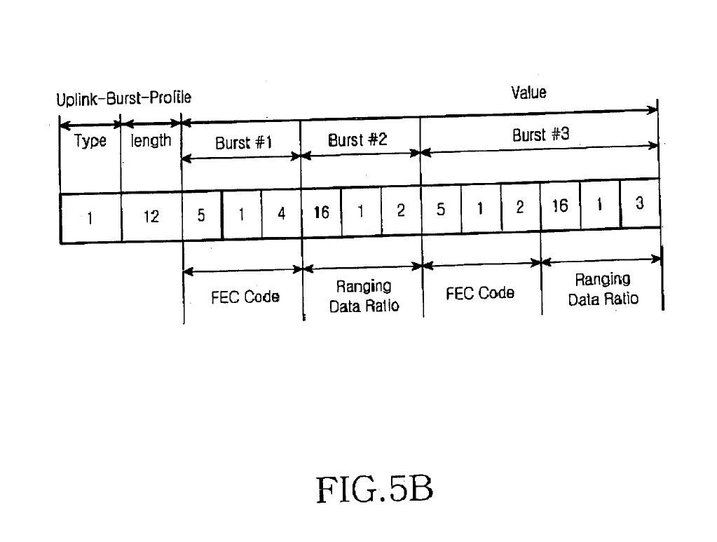

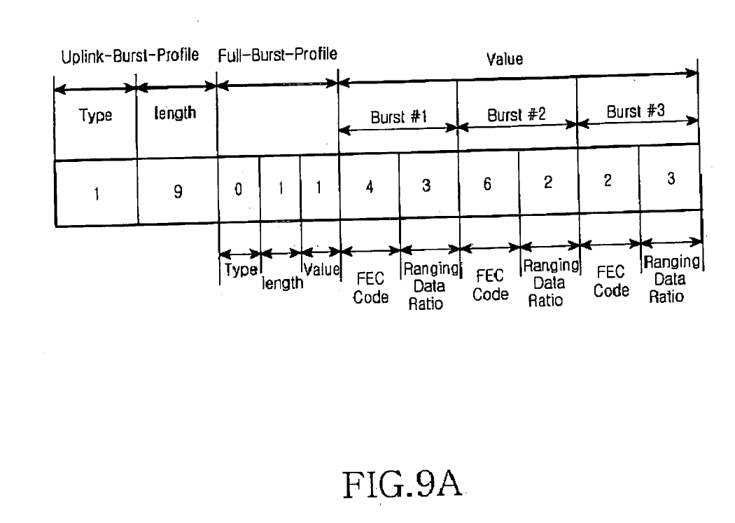

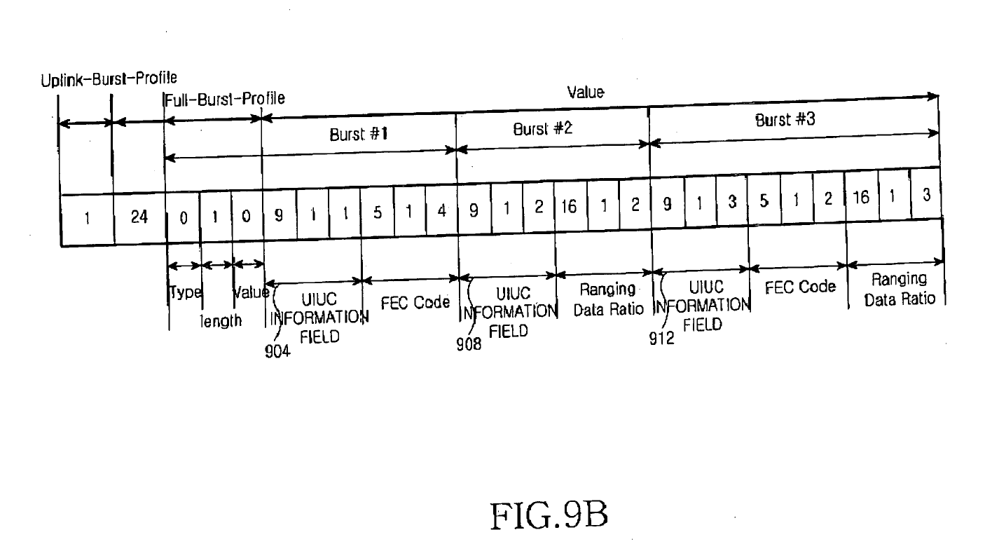

FIG. 9A illustrates an uplink burst profile frame format of a UCD message when transferring the UCD message in a broadband wireless access communication system according to an embodiment of the present invention. Different from the conventional uplink burst profile frame format of the UCD message illustrated in FIG. 5A, which is used for transferring the UCD message, the uplink burst profile frame format according to the present invention indicates that only a value field for each UIUC is transferred with respect to each UIUC by adding the “Full_Burst_profile” field to the uplink burst profile frame format, and then, forms the uplink burst profiles including value fields of FEC codes and ranging data ratios of UIUCs. As a result, all fields of uplink burst profiles for all UIUCs can transmit only value fields in the order of the UIUCs, without including type and length fields. Therefore, overheads can be reduced because the uplink burst profiles do not have type and length fields, unlike the uplink burst profiles as illustrated in FIG. 5A.

FIG. 9B illustrates an uplink burst profile frame format of a UCD message when transferring the UCD message in a broadband wireless access communication system according to an embodiment of the present invention. Referring to FIG. 9B, if a value filed of the “Full_Burst_Profile” field has a value of ‘0’, the subscriber terminal 10 receiving the uplink burst profile reads UIUC fields 904, 908, and 912 and finds an information field of the subscriber terminal 10. That is, the “Full_Burst_Profile” field enables an uplink burst profile TLV encoding channel to include a UIUC field mapped with each burst profile.

Accordingly, the subscriber terminal 10 receiving the UCD message reads the UIUC field and decides UIUCs mapped with TLV-encoded uplink burst profiles. More specifically, the UIUC field includes a value of a type field ‘15’, a value of a length field ‘1’, and a value field having a UIUC number mapped with an uplink burst profile. Also, if the UIUC field is included in the uplink burst profile, the subscriber terminal 10 can decide UIUCs corresponding to TLV-encoded uplink burst profiles.

As described above, according to the present invention, UIUCs mapped with TLV-encoded uplink burst profiles can be distinguished from other UIUCs by inserting UIUC fields mapped with uplink burst profiles into uplink burst profile TLV encoding channels.

Also, according to the present invention, if it is necessary to transfer overall UCD messages including UIUC fields, the “Full_Burst_Profile” field is added to the UCD messages in order to reduce overheads caused by the UIUC fields. At this time, received UCD messages including the “Full_Burst_Profile” field have the uplink burst profiles received in the order of UIUCs 1 to n. In this case, the UIUC field can be omitted.

As described above, according to the present invention, even if only an uplink burst profile corresponding to one UIUC is changed because of inserting UIUC fields mapped with uplink burst profiles into an uplink burst profile TLV encoding channel, only a corresponding uplink burst profile needs to be transferred, instead of transferring uplink burst profiles corresponding to all UIUCs. As a result, downlink overheads can be greatly reduced. Also, only value fields are transferred in the order of UIUC1 to UIUCn, without transferring type and length fields through the UCD message having the “Full_Burst_Profile” field set as ‘1’, also greatly reducing overheads.

While the present invention has been shown and described with reference to certain preferred embodiments thereof, it will be understood by those skilled in the art that various changes in form and details may be made therein without departing from the spirit and scope of the present invention. For example, the present invention may be adaptable for a DCD message.

Additionally, several systems using UCD/DCD messages and having different physical layers may exist. For example, when the physical layer uses a single carrier, the present invention can be applied to all systems using the UCD/DCD messages regardless of the types of the physical layers of the systems, such as an OFDM scheme, an OFMDA scheme, an FDMA scheme, etc. Consequently, the scope of the invention should not be limited to the embodiments described herein, but should be defined by the appended claims and equivalents thereof.

1. A method for transmitting a control message in a wireless access communication system including at least one base station and a plurality of subscriber terminals, the method comprising the steps of:
determining if burst profiles for each of the plurality of subscriber terminals are changed; and
if the burst profiles for only some of the plurality of subscriber terminals are changed, creating and transmitting, by the base station, the control message including a field for identifying each of the subscriber terminals for which the burst profiles are changed and a changed burst profile for each of the subscriber terminals for which the burst profiles are changed.

2. The method as claimed in claim 1, further comprising the steps of:
if the burst profiles for each of the plurality of subscriber terminals are changed, creating the control message by setting only a changed data value of each of the plurality of subscriber terminals; and
transmitting the control message.

3. The method as claimed in claim 1, wherein the control message includes an indication field for indicating if the burst profiles of all or some of the subscriber terminals have been changed according to a result of the determining step.

4. The method as claimed in claim 1, wherein the control message includes an uplink channel descriptor (UCD) message.

5. The method as claimed in claim 1, wherein the control message includes a downlink channel descriptor (DCD) message.

6. The method as claimed in claim 1, wherein the field for identifying each of the subscriber terminals utilizes an uplink interval usage code in an uplink burst profile.

7. The method as claimed in claim 1, wherein the field for identifying each of the subscriber terminals utilizes a down interval usage code in a downlink burst profile.

8. A method for generating a control message including an up/downlink burst profile in a wireless access communication system, the method comprising the steps of:
inserting an indicator field into the control message, the field indicating whether information fields of all of the up/downlink burst profile corresponding to each subscriber terminal UIUC are transmitted or the information fields of some of the up/downlink burst profile are selectively transmitted; and
inserting only a data value field from among the information fields of all of the up/downlink burst profile into the control message, if the indicator field indicates that the information fields of all of the up/downlink burst profile are transmitted.

9. The method as claimed in claim 8, wherein, if the field indicates that the information fields of some of the up/downlink burst profile are selectively transmitted, the up/downlink burst profile includes an identification field for identifying an up/downlink interval usage code of each subscriber terminal.

10. The method as claimed in claim 9, wherein the up/downlink burst profile includes the identification field for identifying an up/downlink interval usage code representing each data interval and at least one of a type field, a length field, and a data value field representing information about the up/downlink interval usage code.

11. A control message for in a wireless access communication system, comprising:
an uplink/down link burst profile including a field for distinguishing an uplink/down link interval usage code (UIUC/DIUC) of each of a plurality of subscriber terminals.

12. The control message as claimed in claim 11, wherein the up/down link burst profile comprises:
a field for distinguishing a UIUC/DIUC representing each data interval from other UIUC/DIUCs; and
at least one of a type field, a length field, and a value field for identifying information of the UIUC/DIUC.

13. The control message as claimed in claim 11, further comprising a field for indicating if all fields of the up/down link burst profile corresponding to each UIUC representing all data intervals are transferred.

14. The control message as claimed in claim 13, further comprising only the data value field from among the information fields of the up/down link burst profile when all fields of up/down link burst profiles corresponding to all UIUCs are transferred.
